(19) United States
(12) Patent Application Publication
(10) Pub. No.: US 2022/0268639 A1
(43) Pub. Date: Aug. 25, 2022

(54) TEMPERATURE SENSOR AND HEATING STRUCTURE COMPRISING SAME

(71) Applicant: INTERFLEX CO., LTD, Ansan-si, Gyeonggi-do (KR)

(72) Inventors: Jin KEUM, Seoul (KR); Chan Woo YANG, Siheung-si, Gyeonggi-do (KR)

(73) Assignee: INTERFLEX CO., LTD, Ansan-si, Gyeonggi-do (KR)

(21) Appl. No.: 17/629,784

(22) PCT Filed: Jul. 26, 2019
(86) PCT No.: PCT/KR2019/009339

§ 371 Date: Apr. 11, 2022

(51) Int. Cl. G01K 7/16; H01C 7/18; H01C 7/00

(52) U.S. Cl. CPC G01K 7/16; H01C 7/18; H01C 7/006

(57) ABSTRACT

The present invention measures a temperature of a heating element and includes a first insulating layer having an electrical insulating function; a sensor electrode provided on an upper side of the first insulating layer and having a change in intensity of a current according to a change in heat generated by the heating element; and a second insulating layer covering an upper side of the sensor electrode, wherein the sensor electrode is disposed in parallel with the first insulating layer and having a plurality of bent portions from one end of the sensor electrode to the other end of the sensor electrode.

### TECHNICAL FIELD

The present invention relates to a temperature sensor and a heating structure including the temperature sensor, and more particularly, to a temperature sensor for measuring a temperature of a heating element and a heating structure including the same.

### BACKGROUND

In general, a heating structure indicates a structure that generates heat by receiving a current from an external power supply. The heating structure includes a heating element, a supply electrode connected to the external power supply and supplying a current to the heating element, and an insulating layer electrically insulating the heating element and the supply electrode from other components. The heating structure is used in various devices such as electronic cigarettes, electric heating mats, and industrial heating appliances and supplies heat to a desired space or components.

Meanwhile, a temperature sensor is usually installed in the heating structure. A temperature sensor measures a temperature of the heating element and transfers the measured information to a separate controller. Therefore, an operator adjusts intensity of a current supplied to the heating element through the supply electrode based on temperature information of the heating element stored in the controller.

In this case, according to a heating structure of the related art, a temperature sensor is manufactured in a chip type. The chip-type temperature sensor has a problem in that the chip-type temperature sensor has to be attached to a heating element by using a separate adhesive. In addition, the chip-type temperature sensor has a limit in an area in contact with the heating element, and thus, a temperature of the heating element cannot be accurately measured.

### SUMMARY OF INVENTION

### Technical Problem

The present invention is derived to solve the above problems and provides a temperature sensor that can be easily attached to a heating element without a separate adhesive and is in contact with the heating element through a larger area and provides a heating structure including the temperature sensor.

### Solution to Problem

According to an aspect of the present invention, a temperature sensor for measuring a temperature of a heating element includes a first insulating layer having an electrical insulating function; a sensor electrode provided on an upper side of the first insulating layer and having a change in intensity of a current according to a change in heat generated by the heating element; and a second insulating layer covering an upper side of the sensor electrode, wherein the sensor electrode is disposed in parallel with the first insulating layer and having a plurality of bent portions from one end of the sensor electrode to the other end of the sensor electrode.

According to another aspect of the present invention, a heating structure includes a heating element; a supply electrode connected to an external power supply to supply a current to the heating element; and a temperature installed on one side of the heating element to measure a temperature of the heating element, wherein the temperature sensor includes a first insulating layer of a thin film shape, a sensor electrode provided on an upper side of the first insulating layer and having a change in intensity of a current according to a change in heat generated by the heating element, and a second insulating layer covering an upper side of the sensor electrode, and the sensor electrode is disposed in parallel with the first insulating layer and having a plurality of bent portions from one end of the sensor electrode to the other end of the sensor electrode.

The sensor electrode has one end and the other end, each having a resistance value of 10 to 1000 Ω.

The sensor electrode is formed by using an etching method.

The sensor electrode includes a first electrode layer including a material selected from nickel, molybdenum, and silver, and a second electrode layer provided on the first electrode layer and including copper.

The first electrode layer has a thickness of 0.1 to 1 μm, and the second electrode layer has a thickness of 1 to 50 μm.

The heating structure according to the present invention further includes a third insulating layer on which the heating element and the supply electrode are provided, and a fourth insulating layer covering upper sides of the heating element and the supply electrode, wherein the temperature sensor is provided on an upper surface of the fourth insulating layer.

The heating structure according to the present invention further includes a metal layer on which the third insulating layer is provided.

The heating structure according to the present invention further includes a third insulating layer provided on lower sides of the heating element and the supply electrode and disposed on a lower side of the first insulating layer, a fourth insulating layer covering the lower sides of the heating element and the supply electrode, and a metal layer located between the first insulating layer and the third insulating layer.

### Advantageous Effects of Invention

According to a temperature sensor and a heating structure including the temperature sensor of the present invention, a film-type temperature sensor includes a first insulating layer of a thin film, a sensor electrode provided on the first insulating layer and having a plurality of bent portions, and a second insulating layer covering the sensor electrode, and thus, the temperature sensor can be more easily attached to a heating element and can be in contact with the heating element through a larger area.

In addition, the temperature sensor and the heating structure including the temperature sensor according to the present invention has an advantage in that a response time to temperature is faster than the response time of the chip-type temperature sensor of the related art. That is, the temperature sensor and the heating structure including the temperature sensor according to the present invention includes a film-type temperature sensor, and thus, it is possible to form a thickness less than the thickness of the chip-type temperature sensor of the related art and to maintain a lower heat capacity, and a reaction time (resistance value change) by heat is increased.

### BRIEF DESCRIPTION OF DRAWINGS

FIG. 1 is an exploded perspective view of a heating structure according to the present invention.

FIG. 2 is a cross-sectional view taken along line A-A of a temperature sensor illustrated in FIG. 1.

FIG. 3 is a cross-sectional view of a sensor electrode illustrated in FIG. 2.

FIG. 4 is a cross-sectional view taken along line A-A of a heating structure illustrated in FIG. 1 and is a view illustrating a first embodiment of the heating structure according to the present invention.

FIG. 5 is a cross-sectional view taken along line A-A of a heating structure illustrated in FIG. 1 and is a view illustrating a second embodiment of the heating structure according to the present invention.

FIG. 6 is a cross-sectional view taken along line A-A of a heating structure illustrated in FIG. 1 and is a view illustrating a third embodiment of the heating structure according to the present invention.

FIGS. 7 to 10 are plan views of FIG. 1 and illustrate various patterns of a heating element and a sensor electrode.

### BEST MODE FOR INVENTION

Although the present invention is described with reference to the embodiments illustrated in the drawings, the embodiments are only examples, and those skilled in the art will understand that various modifications and equivalent other embodiments can be made therefrom. Therefore, the true technical protection scope of the present invention should be determined by the technical idea of the appended claims.

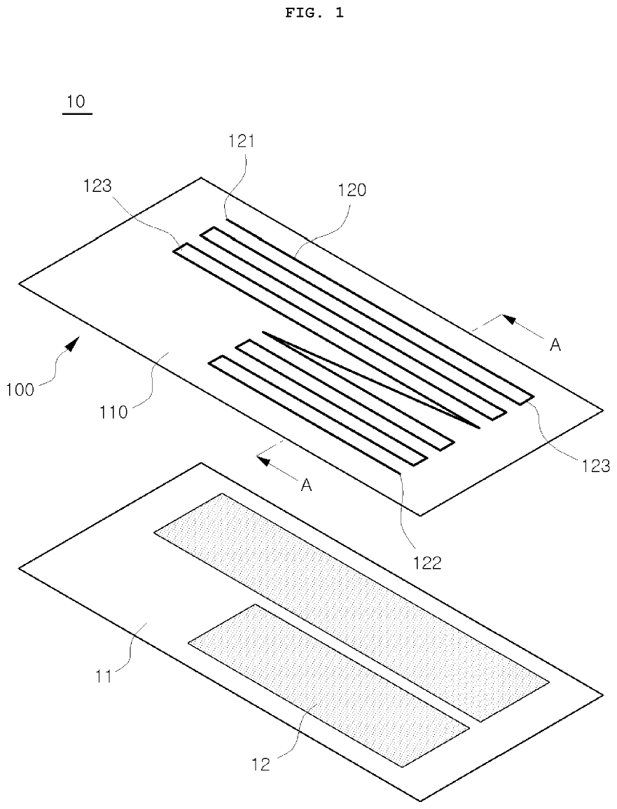

Hereinafter, a temperature sensor according to the present invention and a heat generating structure including the temperature sensor will be described in detail with reference to FIGS. 1 to 10.

Referring to FIGS. 1 to 4, a temperature sensor 100 according to the present invention is installed on an upper side of a heating element 12 to measure a temperature of the heating element 12. To this end, the temperature sensor 100 according to the present invention includes a first insulating layer 110, a sensor electrode 120, and a second insulating layer 130. The first insulating layer 110 is formed of a thin film and has an electrical insulating function. The sensor electrode 120 is provided on an upper side of the first insulating layer 110, and intensity of a current flowing therethrough is changed according to a change in heat generated by the heating element 12. The sensor electrode 120 is connected to an external controller (not illustrated), and the controller calculates the amount of change in heat of the heating element 12 based on the change in intensity of a current flowing through the heating element 12. In addition, the controller infers a current temperature indicated by the heating element 12 based on the calculated amount of change in heat. Based on the inferred temperature value of the heating element 12, intensity of a current supplied to the heating element 12 through the supply electrode 13 is adjusted.

As illustrated in FIGS. 7 to 10, the sensor electrode 120 is disposed in parallel with the first insulating layer 130 and has a plurality of bent portions 123 from one end 121 to the other end 122. Although FIGS. 7 to 10 illustrate that the sensor electrode 120 is bent at a right angle in the plurality of bent portions 123, this is only an example, and the sensor electrode 120 can also be bent to have a curvature at the plurality of bent portions 123 or can also be bent to have an angle other than the right angle.

The second insulating layer 130 covers an upper side of the sensor electrode 120. Accordingly, the temperature sensor 100 is designed to have a film-type structure as a whole because the first insulating layer 110, the sensor electrode 120, and the second insulating layer 130 are stacked. Therefore, according to the temperature sensor 100 and the heating structure 10 including the temperature sensor 100, the temperature sensor 100 can be more easily attached to the heating element 12 and can be in contact with the heating element 12 through a larger area, compared to the chip-type temperature sensor 100 of the related art.

The sensor electrode 120 can be formed such that one end 121 and the other end 122 thereof each has a resistance value of 10 to 1000 Ω. When the resistance values of the one end 121 and the other end 122 of the sensor electrode 120 are less than 10 Ω or greater than 1000 Ω, a temperature measurement function performed by using the sensor electrode 120 is significantly reduced. Therefore, in order to more effectively measure a temperature of the heating element 12 through the sensor electrode 120, the one end 121 and the other end 122 of the sensor electrode 120 can each have a resistance value of 10 to 1000 Ω.

The sensor electrode 120 can be formed by using an etching method. The etching method indicates a method by which only a necessary part of an object remains and the other part is removed by using a chemical solution or gas. The etching method includes a dry etching method using gas, plasma, or an ion beam, and a wet etching method using chemicals. When the sensor electrode 120 is formed by using the etching method, a pattern of the sensor electrode 120 desired by an operator can be more precisely formed on the first insulating layer 110.

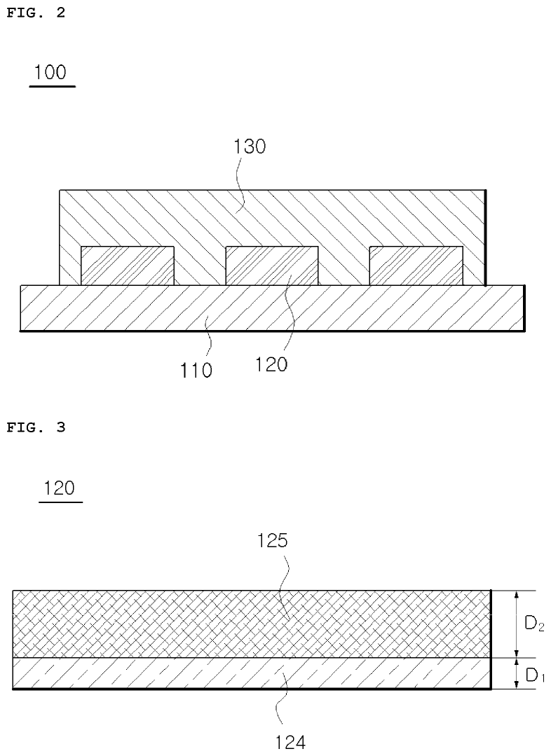

Referring to FIG. 3, the sensor electrode 120 can include a first electrode layer 124 and a second electrode layer 125. The first electrode layer 124 includes any material with an amount of 30% or more by weight, which is selected from nickel, molybdenum, and silver. The second electrode layer 125 is provided on an upper side of the first electrode layer 124 and includes copper. Nickel, molybdenum, and silver are materials with strong corrosion resistance, and copper is a material with high conductivity. Therefore, when the first electrode layer 124 is formed of nickel, molybdenum, or silver and the second electrode layer 125 is formed of copper, both corrosion resistance and conductivity of the sensor electrode 120 can be increased.

In this case, the first electrode layer 124 can have a thickness D1 of 0.1 to 1 μm, and the second electrode layer 125 can have a thickness D2 of 1 to 50 μm. In order to change intensity of a current flowing through the sensor electrode 120 according to a change in heat generated by the heating element 12, a thickness of the sensor electrode 120 has to be a certain extent. In this case, because the second electrode layer 125 has superior conductivity compared to the first electrode layer 124, the first electrode layer 124 has the thickness D1 of 0.1 to 1 μm, and the second electrode layer 125 has the thickness D2 of 1 to 50 μm to provide a more effective temperature measurement function.

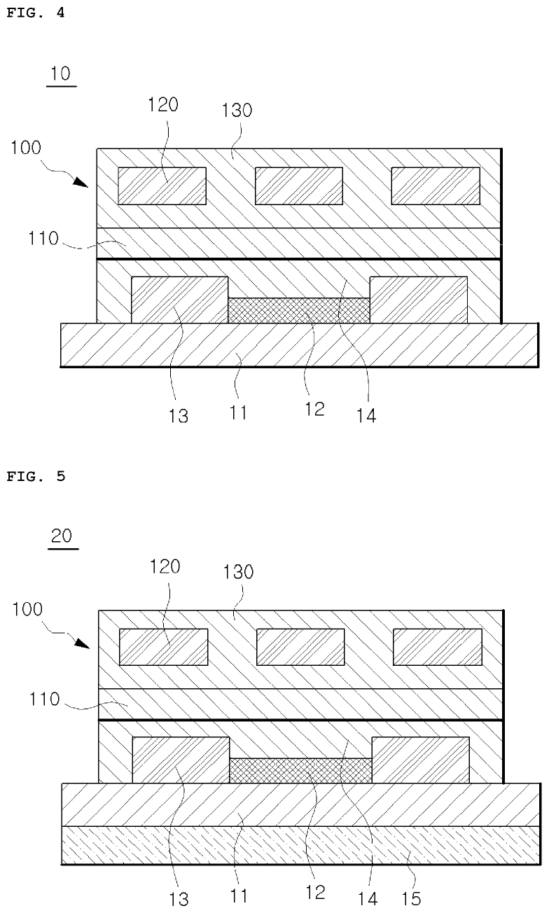

Hereinafter, heating structures 10, 20, and 30 according to first to third embodiments of the present invention will be described with reference to FIGS. 4 to 6. In this case, the second embodiment of the present invention will be described on only a difference from the first embodiment. In addition, the third embodiment of the present invention will be described on only a difference from the second embodiment.

Referring to FIG. 4, a heating structure 10 according to the first embodiment of the present invention includes the temperature sensor 100 described above, a third insulating layer 11, a heating element 12, a supply electrode 13, and a fourth insulating layer 14. The third insulating layer 11 is disposed below the temperature sensor 100. The heating element 12 is disposed between the third insulating layer 11 and the temperature sensor 100 and is provided on the third insulating layer 11. The supply electrode 13 is disposed between the third insulating layer 11 and the temperature sensor 100 and is connected to the heating element 12. In addition, the supply electrode 13 applies a current supplied from an external power supply (not illustrated) to the heating element 12. The heating element 12 receiving a current from the supply electrode 13 generates heat. The fourth insulating layer 14 is located between the heating element 12 and the temperature sensor 100 and covers upper sides of the heating element 12 and the supply electrode 13. In addition, the first insulating layer 110 is provided on an upper side of the fourth insulating layer 14.

Referring to FIG. 5, the heating structure 20 according to the second embodiment of the present invention further includes a metal layer 15 compared to the first embodiment of the present invention. The metal layer 15 is disposed below the third insulating layer 11. In addition, the metal layer 15 is in contact with a heating object (not illustrated) and transfers heat generated by the heating element 12 to a heating object.

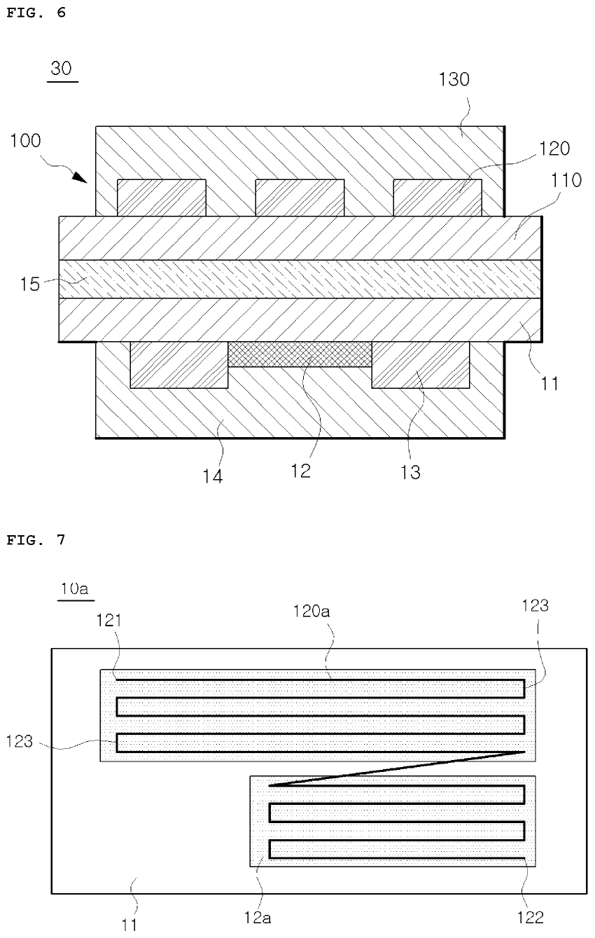

Referring to FIG. 6, the heating structure 30 according to the third embodiment of the present invention is designed to have a structure in which the third insulating layer 11, the heating element 12, the supply electrode 13, the fourth insulating layer 14, and the metal layer 15 are turned upside down. That is, as illustrated in FIG. 6, the metal layer 15, the third insulating layer 11, the heating element 12, the supply electrode 13, and the fourth insulating layer 14 are sequentially formed downward from the first insulating layer 110. In this case, according to the second embodiment of the present invention, the metal layer 15 transfers the heat generated by the heating element 12 to an object to be heated, and according to the third embodiment of the present invention, the metal layer 15 transfers the heat generated by the heating element 12 to the sensor electrode 120. According to the heating structure 30 of the third embodiment of the present invention described above, a temperature of the heating element 12 can be measured more smoothly by the temperature sensor 100.

Hereinafter, various modification examples of heating elements 12a, 12b, 12c, and 12d and sensor electrodes 120a, 120b, 120c, and 120d will be described with reference to FIGS. 7 to 10.

Referring to FIGS. 7 and 8, the heating elements 12a and 12b can each be disposed on the third insulating layer 11 in two or more pieces separated from each other. In addition, the sensor electrodes 120a and 120b can be respectively disposed in patterns on upper sides of the heating elements 12a and 12b.

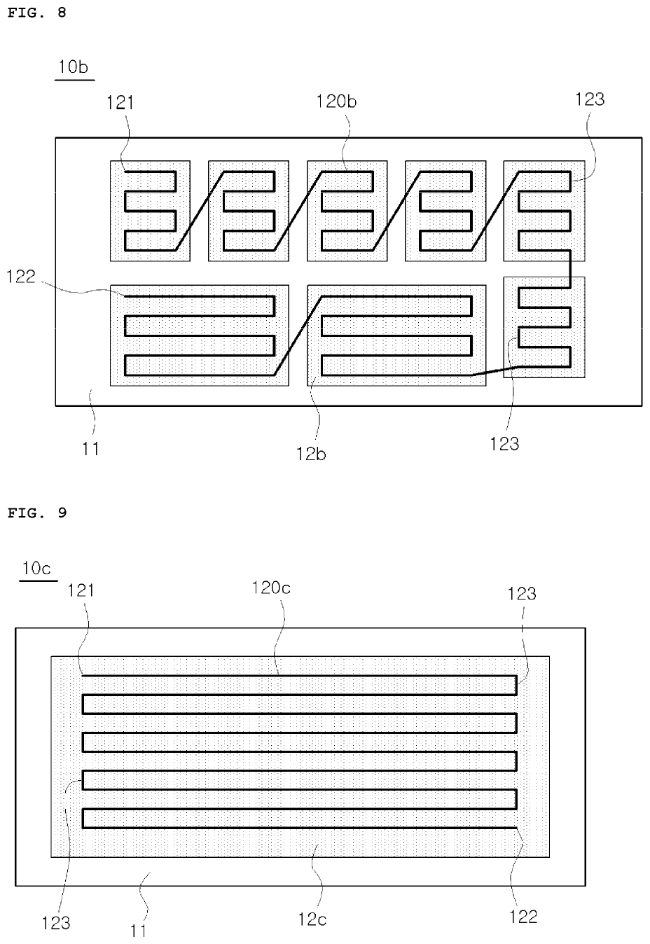

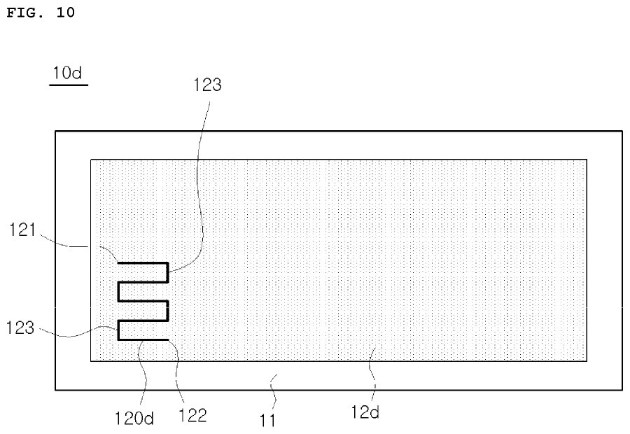

Referring to FIGS. 9 and 10, the heating elements 12c and 12d can each be formed as a single piece on the third insulating layer 11. In addition, the sensor electrodes 120c and 120d can be respectively patterned on the heating element 12c and 12d. In this case, the sensor electrode 120c can be formed to cover most of the area of the heating element 12c as illustrated in FIG. 9 or the sensor electrode 120d can be formed to cover only a small portion of the heating element 12d as illustrated in FIG. 10.

Therefore, according to the heating structures 10a, 10b, 10c, and 10d illustrated in FIGS. 7 to 10, various parts of the heating elements 12a, 12b, 12c, and 12d desired by an operator can be measured by changing patterns and shapes of the sensor electrodes 120a, 120b, 120c, and 120d and the temperature sensor 100 according to the purpose of the operator.

As described above, according to a temperature sensor and a heating structure including the temperature sensor of the present invention, a film-type temperature sensor includes a first insulating layer of a thin film, a sensor electrode provided on the first insulating layer and having a plurality of bent portions, and a second insulating layer covering the sensor electrode, and thus, the temperature sensor can be more easily attached to a heating element and can be in contact with the heating element through a larger area.

In addition, the temperature sensor and the heating structure including the temperature sensor according to the present invention has an advantage in that a response time to temperature is faster than the response time of the chip-type temperature sensor of the related art. That is, the temperature sensor and the heating structure including the temperature sensor according to the present invention includes a film-type temperature sensor, and thus, it is possible to form a thickness less than the thickness of the chip-type temperature sensor of the related art and to maintain a lower heat capacity, and a reaction time (resistance value change) by heat is increased.

1. A temperature sensor for measuring a temperature of a heating element, comprising:
a first insulating layer having an electrical insulating function;
a sensor electrode provided on an upper side of the first insulating layer and having a change in intensity of a current according to a change in heat generated by the heating element; and
a second insulating layer covering an upper side of the sensor electrode,
wherein the sensor electrode is disposed in parallel with the first insulating layer and having a plurality of bent portions from one end of the sensor electrode to the other end of the sensor electrode.

2. The temperature sensor of claim 1, wherein
the sensor electrode has one end and the other end, each having a resistance value of 10 to 1000 Ω.

3. The temperature sensor of claim 1, wherein
the sensor electrode is formed by using an etching method.

4. The temperature sensor of claim 1, wherein
the sensor electrode includes a first electrode layer including a material selected from nickel, molybdenum, and silver, and a second electrode layer provided on the first electrode layer and including copper.

5. The temperature sensor of claim 4, wherein
the first electrode layer has a thickness of 0.1 to 1 μm, and
the second electrode layer has a thickness of 1 to 50 μm.

6. A heating structure comprising:
a heating element;
a supply electrode connected to an external power supply to supply a current to the heating element; and
a temperature installed on one side of the heating element to measure a temperature of the heating element,
wherein the temperature sensor includes a first insulating layer of a thin film shape, a sensor electrode provided on an upper side of the first insulating layer and having a change in intensity of a current according to a change in heat generated by the heating element, and a second insulating layer covering an upper side of the sensor electrode, and
the sensor electrode is disposed in parallel with the first insulating layer and having a plurality of bent portions from one end of the sensor electrode to the other end of the sensor electrode.

7. The heating structure of claim 6, wherein
the sensor electrode has one end and the other end, each having a resistance value of 10 to 1000 Ω.

8. The heating structure of claim 6, wherein
the sensor electrode is formed by using an etching method.

9. The heating structure of claim 6, wherein
the sensor electrode includes a first electrode layer including a material selected from nickel, molybdenum, and silver, and a second electrode layer provided on the first electrode layer and including copper.

10. The heating structure of claim 9, wherein
the first electrode layer has a thickness of 0.1 to 1 μm, and
the second electrode layer has a thickness of 1 to 50 μm.

11. The heating structure of claim 6, further comprising:
a third insulating layer on which the heating element and the supply electrode are provided; and
a fourth insulating layer covering upper sides of the heating element and the supply electrode,
wherein the temperature sensor is provided on an upper surface of the fourth insulating layer.

12. The heating structure of claim 11, further comprising:
a metal layer on which the third insulating layer is provided.

13. The method of claim 6, further comprising:
a third insulating layer provided on lower sides of the heating element and the supply electrode and disposed on a lower side of the first insulating layer;
a fourth insulating layer covering the lower sides of the heating element and the supply electrode; and
a metal layer located between the first insulating layer and the third insulating layer.
